(19) United States
(12) Patent Application Publication
(10) Pub. No.: US 2025/0037115 A1
(43) Pub. Date: Jan. 30, 2025

(54) Methods and Systems for Managing Programmable Currency-Based Transactions Through Nested Smart Contract-Based Wallets

(71) Applicant: Mastercard International Incorporated, New York, NY (US)

(72) Inventors: Chandrudu K., Karimnagar (IN); Yatin Katyal, Rohtak (IN); Sarthak Pujari, Sambalpur (IN)

(21) Appl. No.: 18/785,458

(22) Filed: Jul. 26, 2024

(30) Foreign Application Priority Data
Jul. 27, 2023 (IN) 202341050828

(51) Int. Cl. G06Q 20/36; G06Q 20/10

(52) U.S. Cl. CPC G06Q 20/3678; G06Q 20/10

(57) ABSTRACT

Methods and systems for managing programmable currency-based transactions through nested smart contract-based wallets are disclosed. Method performed by a server system includes receiving fund transfer of a digital currency associated with a smart contract including a set of predefined instructions from a first wallet to a second wallet. Method includes determining a transaction category of the digital currency based on the set of predefined instructions. Transaction category indicates purpose of the fund transfer as per the smart contract. Method includes generating and depositing the digital currency to new sub-wallet(s) associated with the second wallet based on the transaction category of the digital currency. Each of the new sub-wallet(s) is eligible to hold the digital currency for a specific transaction category. Alternatively, the method includes depositing the digital currency to preexisting sub-wallet(s). Each of the preexisting sub-wallet(s) is eligible to hold the digital currency for the specific transaction category.

### TECHNICAL FIELD

The present disclosure relates to a field of blockchain-based digital currency and, more particularly, to methods and systems for managing programmable digital currency-based transactions through nested smart contract-based wallets in a blockchain network.

### BACKGROUND

With the advancement of technology, various countries have started developing their digital currencies. These digital currencies are generally operated on a permissioned blockchain network or a centralized blockchain. As may be understood, digital currencies offer various benefits such as financial inclusion, enhanced security, traceability, reduced transaction fees, enhanced tax collection, and so on. A few examples of existing digital currencies or central bank digital currencies (CBDC) include the digital rupee (e-Rupee) by the Reserve Bank of India (RBI), the digital Renminbi (RMB) by the People's Bank of China, e-Naira by the Central Bank of Nigeria, digital Ruble by Russia, and so on. The term “central bank digital currency” refers to a form of digital currency that is issued by a country's central government. It is to be noted that CBDC is similar to cryptocurrencies, except that its value is fixed by a central bank and is equivalent to the country's fiat currency. Generally, for performing payment transactions using CBDC, a user requires a CBDC wallet that can hold, send, and receive CBDC funds to and from different sources. Although the CBDC has appeared to be promising in experimental settings, its actual implementation leaves much to be desired. For instance, existing CBDC wallets have a user experience problem, majorly towards accessibility and lack of proper infrastructure to build upon.

To that note, it may be understood that the current CBDC wallets are owned by banks. Thus, such CBDC wallets are analogous to wallets that are associated with an Externally Owned Account (EOA), which requires users to have a public key and private key (or Personal Identification Number (PIN)) combination to access their wallets. This process is complex and difficult for a user to understand its creation and usage, therefore, has been limited to technology enthusiasts only, lacking widespread adoption. Further, the existing CBDC wallets offered by banking institutions are unable to leverage the benefit of programmability that comes with digital currencies.

Thus, a technological need exists for improved methods and systems for providing a digital infrastructure that can be integrated with the existing CBDC infrastructure, thereby providing a platform with a better user experience leveraging the programmability feature for the CBDC.

### SUMMARY

Various embodiments of the present disclosure provide methods and systems for managing programmable currency-based transactions through nested smart contract-based wallets.

In an embodiment, a computer-implemented method for managing programmable currency-based transactions through nested smart contract-based wallets is disclosed. The computer-implemented method performed by a server system includes receiving a fund transfer of a digital currency from a first wallet to a second wallet. The digital currency is associated with at least one smart contract. Herein, the smart contract includes a set of predefined instructions. Further, the computer-implemented method includes determining a transaction category of the digital currency based, at least in part, on the set of predefined instructions. Herein, the transaction category indicates the purpose of the fund transfer as per the smart contract. Further, the computer-implemented method includes generating and depositing the received digital currency to one or more new sub-wallets associated with the second wallet based, at least in part, on the transaction category of the received digital currency. Herein, each of the one or more new sub-wallets is eligible to hold the digital currency for a specific transaction category. Alternatively, the computer-implemented method includes depositing the received digital currency to one or more preexisting sub-wallets. Herein, each of the one or more preexisting sub-wallets is eligible to hold the digital currency for the specific transaction category.

In another embodiment, a computer-implemented method is disclosed. The computer-implemented method performed by a server system includes receiving a fund transfer request from a wallet owner of a second wallet to transfer funds to a third wallet. Herein, the fund transfer request is associated with a digital currency deposited in a preexisting sub-wallet of the second wallet. The computer-implemented method includes accessing wallet category data from a database associated with the server system. Further, the computer-implemented method includes determining a wallet category of the third wallet based, at least in part, on the wallet category data. Furthermore, the computer-implemented method includes determining if the preexisting sub-wallet is eligible for transferring funds to the third wallet based, at least in part, on the wallet category and a transaction category of the preexisting sub-wallet. Upon determining that the preexisting sub-wallet is eligible for transferring funds to the third wallet, the computer-implemented method further includes approving and transferring the digital currency from the preexisting sub-wallet to the third wallet based on the fund transfer request. Alternatively, upon determining that the preexisting sub-wallet is not eligible for transferring funds to the third wallet, the computer-implemented method includes declining the fund transfer request.

In yet another embodiment, a server system is disclosed. The server system includes a communication interface and a memory including executable instructions. The server system also includes a processor communicably coupled to the memory. The processor is configured to execute the instructions to cause the server system, at least in part, to receive a fund transfer of a digital currency from a first wallet to a second wallet. The digital currency is associated with at least one smart contract. Further, the smart contract includes a set of predefined instructions. The server system is further caused to determine a transaction category of the digital currency based, at least in part, on the set of predefined instructions. Herein, the transaction category indicates the purpose of the fund transfer as per the smart contract. Furthermore, the server system is caused to perform one of the following operations. One of the operations includes generating and depositing the received digital currency to one or more new sub-wallets associated with the second wallet based, at least in part, on the transaction category of the received digital currency. Herein, each of the one or more new sub-wallets is eligible to hold the digital currency for a specific transaction category. Another operation includes depositing the received digital currency to one or more preexisting sub-wallets. Herein, each of the one or more preexisting sub-wallets is eligible to hold the digital currency for the specific transaction category.

Further, in yet another embodiment, a non-transitory computer-readable storage medium is disclosed. The non-transitory computer-readable storage medium includes computer-executable instructions that, when executed by at least a processor of a server system, cause the server system to perform a method. The method includes receiving a fund transfer of a digital currency from a first wallet to a second wallet. The digital currency is associated with at least one smart contract. Herein, the smart contract includes a set of predefined instructions. Further, the method includes determining a transaction category of the digital currency based, at least in part, on the set of predefined instructions. Herein, the transaction category indicates the purpose of the fund transfer as per the smart contract. Further, the method includes generating and depositing the received digital currency to one or more new sub-wallets associated with the second wallet based, at least in part, on the transaction category of the received digital currency. Herein, each of the one or more new sub-wallets is eligible to hold the digital currency for a specific transaction category. Alternatively, the method includes depositing the received digital currency to one or more preexisting sub-wallets. Herein, each of the one or more preexisting sub-wallets is eligible to hold the digital currency for the specific transaction category.

### BRIEF DESCRIPTION OF THE FIGURES

For a more complete understanding of example embodiments of the present technology, reference is now made to the following descriptions taken in connection with the accompanying drawings in which:

FIG. 1 illustrates an example representation of an environment related to at least some example embodiments of the present disclosure;

FIG. 2 illustrates a simplified block diagram of a server system, in accordance with an embodiment of the present disclosure;

FIG. 3A illustrates a block diagram of a digital architecture associated with the server system, in accordance with an embodiment of the present disclosure;

FIG. 3B illustrates a schematic representation of a digital currency linked with a smart contract and a smart wallet contract, in accordance with an embodiment of the present disclosure;

FIG. 4 illustrates a block diagram of an example wallet having one or more sub- wallets, in accordance with an embodiment of the present disclosure;

FIG. 5 illustrates a block diagram of a flow of a fund transfer from a source wallet to a destination wallet, in accordance with an embodiment of the present disclosure;

FIG. 6 illustrates a process flow diagram depicting a method for facilitating a fund transfer from a first wallet to a second wallet, in accordance with an embodiment of the present disclosure; and

FIG. 7 illustrates a process flow diagram depicting a method for facilitating a fund transfer from the second wallet to a third wallet, in accordance with an embodiment of the present disclosure.

The drawings referred to in this description are not to be understood as being drawn to scale except if specifically noted, and such drawings are only of example in nature.

### DETAILED DESCRIPTION

In the following description, for the purpose of explanation, numerous specific details are set forth in order to provide a thorough understanding of the present disclosure. It will be apparent, however, to one skilled in the art that the present disclosure can be practiced without these specific details. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

Reference in this specification to “one embodiment” or “an embodiment” means that a particular feature, structure, or characteristic described in connection with the embodiment is included in at least one embodiment of the present disclosure. The appearance of the phrase “in an embodiment” in various places in the specification does not necessarily all refer to the same embodiment, nor are separate or alternative embodiments mutually exclusive of other embodiments. Moreover, various features are described which may be exhibited by some embodiments and not by others. Similarly, various requirements are described which may be requirements for some embodiments but not for other embodiments.

Moreover, although the following description contains many specifics for the purposes of illustration, anyone skilled in the art will appreciate that many variations and/or alterations to said details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure.

Embodiments of the present disclosure may be embodied as an apparatus, a system, a method, or a computer program product. Accordingly, embodiments of the present disclosure may take the form of an entire hardware embodiment, an entire software embodiment (including firmware, resident software, micro-code, etc.), or an embodiment combining software and hardware aspects that may all generally be referred to herein as a “circuit”, “engine”, “module”, or “system”. Furthermore, aspects of the present disclosure may take the form of a computer program product embodied in one or more computer-readable storage media having computer-readable program code embodied thereon.

For elucidatory purposes, the terms “digital currency”, “digital money”, “electronic currency”, or “electronic money” have been used interchangeably throughout the description and refers to a form of currency that exists in digital form and is primarily managed, stored, or exchanged on digital computer systems, especially over the internet. Examples of digital currencies include virtual currency, cryptocurrency (or crypto coins), central bank digital currency (CBDC), etc. More specifically, cryptocurrencies are digital assets that operate on their own independent blockchain (i.e., a distributed immutable ledger). Other digital assets include crypto tokens. The terms “crypto tokens”, “cryptocurrency tokens”, or “tokens” have been used interchangeably throughout the description and refer to digital assets that are similar to crypto coins but operate on an existing blockchain network. It is to be noted that crypto coins primarily function as a medium of exchange, whereas crypto tokens can offer a wide range of functionalities within a specific project's ecosystem.

The term “ledger” used throughout the description refers to a collection of accounts in which transactions are recorded, whereas the term “central ledger” may refer to a ledger having a central authority as in charge of keeping and maintaining financial transaction data in the ledger. For example, a bank might employ a centralized ledger to maintain customer account balances, transaction histories, and other financial information. In the case of the CBDC, a central bank can be the central authority.

The terms “wallet”, “digital wallet”, or “electronic wallet”, used interchangeably throughout the description, generally refer to financial transaction applications that run on connected devices facilitating individuals to make electronic transactions. Wallets are traditionally Externally Owned Accounts (EOA) and securely store payment information and passwords in the cloud. More specifically, wallets are used for the transaction of tokens or digital currencies on a blockchain network.

Further, the term “smart contract” used throughout the description refers to simple programs stored on a blockchain that run when predetermined conditions are met. An account is created on the blockchain for facilitating the deployment of the smart contract, which is referred to as a “contract account”.

In a particular implementation, the terms “smart contract wallet”, “smart wallet”, or “smart contract-based wallet”, used interchangeably throughout the description, refer to an Ethereum network-based wallet managed by a smart contract instead of a private key. Alternatively, it may also refer to a wallet built on a new network that has account abstraction capability.

The term “account abstraction” used throughout the description generally refers to an act of separating the control of a wallet from its associated private key and replacing it with a smart contract. Thus, it may be understood that the digital assets of the users are stored in the smart contract rather than in the EOA. The concept of account abstraction provides programmability to the wallet, providing more flexibility and security for transaction of digital assets such as the digital currency between the wallets such as the smart wallets. The digital currency upon application of the account abstraction can also be referred to as a “programmable currency”. In other words, the digital currency that is linked with the smart contract can be referred to as the “programmable currency”.

### Overview

Various embodiments of the present disclosure provide methods, systems electronic devices, and computer program products for managing programmable digital currency-based transactions through nested smart contract-based wallets in a blockchain network. In a non-limiting implementation, the server system may be configured to receive a fund transfer of a digital currency from a first wallet to a second wallet. The digital currency may be associated with at least one smart contract. Herein, the smart contract may include a set of predefined instructions. It is to be noted that, in an embodiment, the server system is also configured to facilitate generation of the at least one smart contract including the set of predefined instructions. Further, the at least one smart contract may be intended to execute the set of predefined instructions upon meeting a predefined condition. Furthermore, the server system may link the at least one smart contract with the digital currency that is to be transferred from the first wallet to the second wallet. Moreover, the server system may transfer the digital currency linked with the at least one smart contract to the second wallet.

The server system may further be configured to determine a transaction category of the digital currency based, at least in part, on the set of predefined instructions. Herein, the transaction category may indicate the purpose of the fund transfer as per the smart contract. In one embodiment, the server system is configured to generate and deposit the received digital currency to one or more new sub-wallets associated with the second wallet based, at least in part, on the transaction category of the received digital currency. Herein, each of the one or more new sub-wallets may be eligible to hold the digital currency for a specific transaction category. In another embodiment, the server system is configured to deposit the received digital currency to one or more preexisting sub-wallets. Herein, each of the one or more preexisting sub-wallets may be eligible to hold the digital currency for the specific transaction category.

In a specific embodiment, the server system generates one or more wallets including the first wallet, the second wallet, and a third wallet based, at least in part, on funds to be transferred through the digital currency. For generating the wallets, the server system may generate one or more Application Programming Interface (API) endpoints for facilitating the exchange of one or more API calls between one or more wallet providers and corresponding one or more financial institutions. Further, the server system may receive a wallet generation request from the one or more wallet providers through the one or more API endpoints. Furthermore, the server system may transfer the wallet generation request to the corresponding one or more financial institutions through the one or more API endpoints. In response to the wallet generation request, the server system may receive a wallet authorization response from the one or more financial institutions. Herein, the wallet authorization response may indicate an authorization of at least one of the one or more wallet providers based, at least in part, on the one or more API calls. In response to the authorization of at least one of the one or more wallet providers, the server system may facilitate the corresponding wallet provider to create the one or more wallets.

In a non-limiting implementation, the server system may link each of the one or more new sub-wallets with at least one wallet smart contract indicating a wallet eligibility condition. As described earlier, the server system may determine an eligibility of the one or more new sub-wallets to hold the digital currency for the specific transaction category. For determining the eligibility, the server system may execute the at least one smart contract associated with the digital currency and the at least one wallet smart contract associated with each of the one or more new sub-wallets. Further, in one embodiment, the server system determines if at least one of the one or more new sub-wallets is eligible to hold the digital currency based at least on the execution of the at least one smart contract and the at least one wallet smart contract. In such an embodiment, the server system determines that the at least one of the one or more new sub-wallets is eligible to hold the digital currency when the execution of the at least one smart contract and the at least one wallet smart contract indicates that the purpose of the corresponding new sub-wallet matches with the transaction category of the digital currency. In such an alternative embodiment, the server system determines that at least one of the one or more new sub-wallets is not eligible to hold the digital currency when the execution of the at least one smart contract and the at least one wallet smart contract indicates that the purpose of the corresponding new sub-wallet mismatches with the transaction category of the digital currency.

In another non-limiting implementation, the server system may link each of the one or more preexisting sub-wallets with at least one wallet smart contract indicating a wallet eligibility condition. As described earlier, the server system may determine an eligibility of the one or more preexisting sub-wallets to hold the digital currency for the specific transaction category. For determining the eligibility, the server system may execute the at least one smart contract associated with the digital currency and the at least one wallet smart contract associated with each of the one or more preexisting sub-wallets. Further, in one embodiment, the server system determines if at least one of the one or more preexisting sub-wallets is eligible to hold the digital currency based at least on the execution of the at least one smart contract and the at least one wallet smart contract. In such as embodiment, the server system determines that at least one of the one or more preexisting sub-wallets is eligible to hold the digital currency when the execution of the at least one smart contract and the at least one wallet smart contract indicates that the purpose of the corresponding preexisting sub-wallet matches with the transaction category of the digital currency. In such another embodiment, the server system determines that at least one of the one or more preexisting sub-wallets is not eligible to hold the digital currency when the execution of the at least one smart contract and the at least one wallet smart contract indicates that the purpose of the corresponding preexisting sub-wallet mismatches with the transaction category of the digital currency.

In a specific scenario, a wallet owner of the second wallet is required to spend the digital currency in the second wallet. Thus, a fund transfer request may be generated which may be received by the server system. The fund transfer request may include a request to transfer the funds from the second wallet to the third wallet. Herein, the fund transfer request may be associated with a digital currency deposited in a preexisting sub-wallet of the second wallet. Further, the server system may access wallet category data from a database associated with the server system. The server system may then determine a wallet category of the third wallet based, at least in part, on the wallet category data. Further, the server system determines if the preexisting sub-wallet is eligible for transferring funds to the third wallet based, at least in part, on the wallet category and a transaction category of the preexisting sub-wallet.

In one embodiment, upon determining that the preexisting sub-wallet is eligible for transferring funds to the third wallet, the server system approves and transfers the digital currency from the preexisting sub-wallet to the third wallet based on the fund transfer request. In another embodiment, upon determining that the preexisting sub-wallet is not eligible for transferring funds to the third wallet, the server system declines the fund transfer request. In a non-limiting implementation, the server system may link the third wallet with at least one wallet smart contract indicating a wallet eligibility condition. As described earlier, the eligibility of the preexisting sub-wallet is also determined to transfer the funds to the third wallet. To determine the eligibility, the server system may execute the at least one smart contract associated with a digital currency of the funds and the at least one wallet smart contract associated with each of the preexisting sub-wallet and the third wallet. In one embodiment, the server system may determine that the preexisting sub-wallet is eligible to transfer the funds in the digital currency to the third wallet when the execution of the at least one smart contract and the at least one wallet smart contract indicates that the wallet category of the third wallet matches with the transaction category of the preexisting sub-wallet. In another embodiment, the server system determines that the preexisting sub-wallet is not eligible to transfer the funds in the digital currency to the third wallet when the execution of the at least one smart contract and the at least one wallet smart contract indicates that the wallet category of the third wallet mismatches with the transaction category of the preexisting sub-wallet.

Various embodiments of the present disclosure offer multiple advantages and technical effects. For instance, the method and the system proposed in the present disclosure enable the customization of wallets through smart contracts, thus supporting multiple use cases. Herein, the wallets can hold multiple sub-wallets which can also be smart contracts, thereby providing a nested smart contract-based framework to the wallets. Further, some smart contracts may trigger the smart contracts of other wallets as well, depending on the use case. For example, an individual can have a sub-wallet in their main wallet dedicated to a subsidy for ration. A smart contract is linked with the sub-wallet, which is programmed such that digital assets within that sub-wallet can only be used at ration shops in that locality. In addition, the smart contract can also be programmed to execute only when data of the merchants such as the ration shops in that locality is accessible to the system facilitating the execution of the smart contract. Thus, it may be understood that such a framework regulates the flow of digital assets between different wallets according to a particular scheme such as any government scheme, reimbursement scheme, or the like. Therefore, the concept of having dedicated sub-wallets within each wallet nested smart contracts or nested smart contract-based framework for the wallets is unique and advantageous.

On that note, for example, an easy disbursement of government subsidy without the danger of money leakage (e.g., due to corruption) is made possible by the system and the method proposed in the present disclosure. Further, the approach proposed in the present disclosure helps in creating a distributed ecosystem with a focus on anonymity and trust. Furthermore, it may be noted that smart contract wallets give the flexibility for developers and third-party applications to set up their security protocols for user onboarding. Moreover, easy customization will give it a competitive edge as compared to existing disbursement systems such as Unified Payments Interface (UPI) payments. Moreover, the digital infrastructure proposed in the present disclosure can be integrated with various technological stacks such as Adhaar, UPI, Open Network for Digital commerce (ONDC), etc.

In addition, if a user forgets the private key, the wallet can be recovered through a social recovery process where a user can designate multiple trusted individuals as recovery agents by creating a smart contract for the same purpose. Further, multi-signature wallets can be implemented, where accounts can be programmed to require multiple signatures before a transaction can be executed, effectively making every account a multi-signature wallet by default. This feature has a lot of real-life use cases such as a communal wallet. It may also be understood that with account abstraction, transactions can be scheduled with a time delay, or according to event-driven flows. This would allow users to set up recurring payments on a self-custodial wallet.

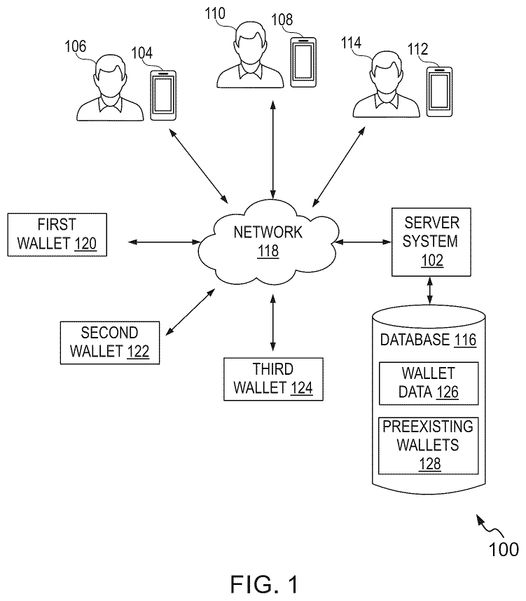

Various example embodiments of the present disclosure are described hereinafter with reference to FIGS. 1 to 7.

FIG. 1 illustrates an example representation of an environment 100 related to at least some example embodiments of the present disclosure. Although the environment 100 is presented in one arrangement, other embodiments may include the parts of the environment 100 (or other parts) arranged otherwise depending on, for example, managing programmable currency-based transactions through nested smart contract-based wallets.

The example representation of the environment 100 as depicted in FIG. 1 includes a server system 102, a first user device 104 associated with a first user 106, a second user device 108 associated with a second user 110, a third user device 112 associated with a third user 114, and a database 116 connected to, and in communication with (and/or with access to), a wireless communication network (e.g., a network 118).

It may be noted that currently, banks provide digital currency wallets such as Central Bank Digital Currency (CBDC) wallets, where users need to enter a secret key such as a Personal Identification Number (PIN) for a particular transaction to happen. However, when compared to traditional banking applications the user experience (UX) has become a major factor for large-scale adoption of CBDC (hereinafter, interchangeably referred to as ‘e-Rupee’) as well as to give a competitive edge to Unified Payments Interface (UPI), which is very user friendly. In addition, existing CBDC wallets lack a proper infrastructure for their deployment and record keeping. Thus, there is a possibility that the funds from such wallets are misused. For instance, the central government may deposit the funds in a CBDC wallet of a particular user as a ration subsidy. Herein, the ration subsidy is meant to be used for purchasing ration items. However, since such transactions are not recorded, the user can misuse these funds by spending them for other purposes such as purchasing illicit goods instead of the ration. Thus, there is a need to build an approach that can facilitate seamless transactions and tracking (i.e., record keeping) of the CBDC between the CBDC wallets without any need to have a secret key.

Therefore, the above-mentioned technical problems, among other problems, are addressed by one or more embodiments implemented by the server system 102 and the methods thereof provided in the present disclosure. It should be noted that the server system 102 is targeted to implement an approach that introduces the concept of smart contract wallets for the transaction of the digital currency such as the CBDC. These wallets are programmable which means every wallet is a smart contract that can contain logic and implement a specific flow.

More specifically, in a non-limiting implementation, the present disclosure proposes a method and a system for managing the programmable currency-based transactions through the nested smart contract-based wallets. In other words, it may be noted that the present disclosure provides a digital infrastructure for developers and/or payment providers (otherwise, also referred to as ‘wallet providers’) of digital currencies to create and operate customized wallets for using programmable money or programmable currency such as the CBDC with user-specific use cases or conditions using smart contract wallets. Herein, the term ‘programmable currency-based transactions’ refers to the transaction of funds in a programmable currency such as the digital currency (e.g., CBDC). Similarly, the term ‘nested smart contract-based wallets’ refers to wallets that are linked with smart contracts and are capable of having multiple sub-wallets. Herein, each sub-wallet can further be linked with another smart contract.

In a non-limiting example, the first user 106 may correspond to a user or an entity that is a source of money or digital currency. In another non-limiting example, the first user 106 can be an entity that initiates a fund transfer of the digital currency to a destination wallet (such as a wallet owned by the second user 110). It is to be noted that the fund transfer may be attached to a spending condition using a smart contract. Herein, the spending condition indicates a condition which, if matched, allows the spending of the funds by the destination wallet. In one embodiment, the first user 106 can be a government institution or entity that wishes to transfer a subsidy (or a government incentive) to one or more wallets of the public. As may be noted herein, the subsidy funds may be restricted by the government entity to be used for a predefined purpose by the public that receives it. In another embodiment, the first user 106 can be a parent who transfers the digital currency to a child's wallet. Herein the digital currency may be programmed to be used only for paying school fees and not for any other purpose. Therefore, it may be noted that the first user 106 may be government, individuals, private firms, banks, a merchant, a service provider, business owners, insurance companies, an employer, other financial institutions, healthcare institutions, or the like.

Similarly, in a non-limiting example, the second user 110 can be a customer or an individual who is dependent on the first user 106 for receiving some funds. Herein, the funds correspond to the programmable currency that is programmed to be used for a specific purpose only. Therefore, in an embodiment, the second user 110 includes any individual, an employee, an employer, a representative of a corporate entity, a child, a student, or any other person who is willing to receive some funds from the first user 106 for several purposes.

Further, in one embodiment, the third user 114 may be a user or an entity where the smart contract linked to the money, or the digital currency executes and ends. Therefore, the third user 114 may be referred to as a destination where the fund transferred from the source was intended to reach. In an embodiment, the third user 114 includes a merchant, a school, a retail store, an institution, the first user 106, or the like.

In various non-limiting examples, the first user device 104, the second user device 108, and the third user device 112 may include any suitable electronic devices such as a smartphone, a personal computer, a laptop, a personal digital assistant (PDA), an electronic tablet, a desktop computer, a wearable device, or a smart device such as site camera, smart TV or smart appliance, a smartwatch, etc., among other suitable electronic devices that are capable of hosting or the operation of the digital currency wallet.

The network 118 may include, without limitation, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, a virtual network, and/or another suitable public and/or private network capable of supporting communication among two or more of the parts or users illustrated in FIG. 1, or any combination thereof.

Various entities in the environment 100 may connect to the network 118 in accordance with various wired and wireless communication protocols, such as Transmission Control Protocol and Internet Protocol (TCP/IP), User Datagram Protocol (UDP), 2^{nd} Generation (2G), 3^{rd} Generation (3G), 4^{th} Generation (4G), 5^{th} Generation (5G) communication protocols, Long Term Evolution (LTE) communication protocols, New Radio (NR) communication protocol, any future communication protocol, or any combination thereof. In some instances, the network 118 may utilize a secure protocol (e.g., Hypertext Transfer Protocol (HTTP), Secure Socket Lock (SSL), and/or any other protocol or set of protocols for communicating with the various entities depicted in FIG. 1.

In several embodiments, the server system 102 can be deployed as a standalone application, client/server, a website, or can be implemented in the cloud as software as a service (SaaS). In a non-limiting implementation, the server system 102 provides or hosts a website or an application on the first user device 104 to enable the first user 106 to access features facilitated by the server system 102 such as creating a smart contract, linking the created smart contract to a digital currency, initiating the fund transfer, executing or triggering the smart contract associated with the received digital currency, and so on. Similarly, an instance of the website or the application can be accessed by the second user 110 which is accessible on the second user device 108. This enables the second user 110 to receive the digital currency that is linked with the smart contract and use it further for the purpose specified by the smart contract linked to the received digital currency. Further, in an embodiment, an instance of the website or the application may also be accessible on the third user device 112 for the third user 114 to be able to receive the funds, execute the smart contract, and end it here.

Further, it may be noted that for the first user 106, the second user 110, and the third user 114 to be able to be involved in fund transfer of the digital currency that is linked with a smart contract, the first user 106, the second user 110 and the third user 114 may have to have their accounts linked with a first wallet 120, a second wallet 122, and a third wallet 124 respectively. Herein, each of the first wallet 120, the second wallet 122, and the third wallet 124 may refer to smart contract-based digital currency wallets having account abstraction capability. Thus, these wallets are able to receive and transfer digital currencies that are linked with smart contracts while also having the ability to trigger or execute the smart contracts. Herein, in one embodiment, each of the one or more wallets, such as the first wallet 120, the second wallet 122, and the third wallet 124 can also be linked with a smart contract such as a wallet smart contract facilitating the wallets to perform multiple functionalities. One of the functionalities can be to trigger or execute the smart contracts that are linked with the digital currency. Other functionalities can include social recovery, fraud monitoring, multi-calls, etc.

It may be noted that during the process, the database 116 may store wallet data 126 and preexisting wallets 128 (may also be referred to hereinafter interchangeably as ‘preexisting sub-wallets 128’ or ‘one or more preexisting sub-wallets 128’) as shown in the environment 100 illustrated in FIG. 1. In various other non-limiting examples, the database 116 may include one or more hard disk drives (HDD), solid-state drives (SSD), an Advanced Technology Attachment (ATA) adapter, a Serial ATA (SATA) adapter, a Small Computer System Interface (SCSI) adapter, a redundant array of independent disks (RAID) controller, a storage area network (SAN) adapter, a network adapter, and/or any component providing the server system 102 with access to the database 116. In one implementation, the database 116 may be viewed, accessed, amended, updated, and/or deleted by an administrator (not shown) associated with the server system 102 through a database management system (DBMS) or relational database management system (RDBMS) present within the database 116.

In some embodiments, since the smart contracts are deployed on the blockchain, the server system 102 may be a node from a decentralized network of nodes. Herein, the node refers to a computer system that is connected to the network in a peer-to-peer (P2P) fashion to keep track of a distributed ledger (e.g., a decentralized blockchain, a centralized blockchain, a permissioned blockchain, or the like.) and serve as communication hubs for various network tasks. It may be noted that the nodes are configured to run protocol software and can store partial or complete copies of the distributed ledger.

In some other embodiments, the server system 102 may be a node from a centralized network of nodes. Herein, the node is a similar entity as defined above, however, the network of nodes is controlled or administered by a single entity that is associated with a centralized ledger. Herein, the single entity may be a business, a government body, a financial institution, or the like. Also, in a specific embodiment, a blockchain can be used as the centralized ledger, however, the blockchain may be a permissioned (or private) blockchain that stores data on the blockchain upon receiving the owner's permission.

It should be understood that the server system 102 is a separate part of the environment 100 and may operate apart from (but still in communication with, for example, via the network 118) any third-party external servers (to access data to perform the various operations described herein). However, in other embodiments, the server system 102 may be incorporated, in whole or in part, into one or more parts of the environment 100.

Further, to enable the management of the programmable currency-based transactions through the nested smart contract-based wallets, the server system 102 may be adapted to perform a plurality of operations that may be explained in detail in further parts of the description with reference to several example figures.

Therefore, initially, when a fund transfer is initiated by the first user 106, as the first user 106 is using the facility provided by the server system 102 via the first user device 104, the server system 102 may receive the fund transfer of a digital currency from the first wallet 120 to the second wallet 122. Herein, the digital currency is associated with at least one smart contract. Further, it may be noted that the smart contract may include a set of predefined instructions.

In an embodiment, the fund transfer may include information corresponding to the funds that are supposed to be transferred from the first wallet 120 to the second wallet 122. For example, the information may include a transaction amount, the purpose of the transaction, the timing of the transfer, details of the first user 106, details of the second user 110, and the like. In another embodiment, the set of predefined instructions that are included in the smart contract may include all the information that is needed to accomplish the fund transfer from the first wallet 120 to the second wallet 122. Therefore, in some embodiments, the smart contract may include account details of the first user 106 and the second user 110, information that is associated with the fund transfer, the purpose of the transaction, and the like.

Upon receiving the fund transfer, the server system 102 is responsible for completing the transfer by checking certain predefined conditions. Therefore, the server system 102 may further determine a transaction category of the digital currency based, at least in part, on the set of predefined instructions. Herein, the transaction category may indicate the purpose of the fund transfer as per the smart contract. For example, the transaction category may include a government-subsidized transaction for specific purposes, a school/college fees-related transaction, a grocery-specific transaction, a business trip-related transaction, a medical insurance-related transaction, a coupon-related transaction, or the like. Therefore, it may be understood that the transaction category is specific to a specific task and varies as the task varies.

Further, in one embodiment, the server system 102 may perform generating and depositing the received digital currency to one or more new sub-wallets associated with the second wallet 122 based, at least in part, on the transaction category of the received digital currency. Herein, each of the one or more new sub-wallets is eligible to hold the digital currency for a specific transaction category. The process of generating the new sub-wallets is explained further in the present disclosure.

In another embodiment, the server system 102 may deposit the received digital currency to one or more preexisting sub-wallets (e.g., the preexisting wallets 128). Herein, each of the one or more preexisting sub-wallets 128 is eligible to hold the digital currency for the specific transaction category. Further, it may be noted that in the case when the one or more new sub-wallets are generated, for the subsequent transaction the same may be considered or referred to as preexisting sub-wallets. In other words, if a new sub-wallet is created for a particular transaction, then for the subsequent transaction, the new sub-wallet will be included in the one or more preexisting sub-wallets 128.

Therefore, it may be understood that, upon receiving the fund transfer, the server system 102 may check if the second wallet 122 already has a specific preexisting sub-wallet within the one or more preexisting sub-wallets 128 for receiving the digital currency for the corresponding transaction category. If the server system 102 fails to find such a specific preexisting sub-wallet, the server system 102 generates a new sub-wallet for the corresponding transaction category. Moreover, the server system 102 generates new sub-wallets in the second wallet 122, as it is facilitated with a nested smart contract feature. The nested smart contract feature enables the wallets that can receive and transfer digital currency linked with smart contracts to have sub-wallets. Herein, a sub-wallet can be dedicated to a specific purpose by linking a smart contract such as a wallet smart contract describing the purpose with the corresponding sub-wallet. Herein, it is to be noted that the wallet smart contract is similar to the smart contract that is linked with the digital currency with the difference being the logic of implementation and being linked to a wallet or a sub-wallet. More specifically, for the deployment of the smart contracts on the blockchain, a contract account may be created on the blockchain for each smart contract linked with each digital currency, wallet, or sub-wallet. Herein, each contract account may be associated with a unique identity (ID) for identification and access to the smart contracts stored in the contract accounts.

Further, in some embodiments, the second user 110 that received the funds in the digital currency can transfer the same digital currency further based on the smart contract that is linked with the corresponding digital currency. Further, when the second user 110 initiates such a request, the request may again be fetched by the server system 102.

To that note, the server system 102 may receive a fund transfer request from a wallet owner (e.g., the second user 110) of the second wallet 124 to transfer funds to the third wallet 124. In one embodiment, the fund transfer request is associated with the digital currency deposited in a preexisting sub-wallet of the second wallet 122. Herein, the preexisting sub-wallet is one of the one or more preexisting sub-wallets 128.

Further, the server system 102 may access wallet category data from the database 116 associated with the server system. Herein, in an embodiment, the wallet data 126 may include the wallet category data corresponding to the third wallet 124. Furthermore, the server system 102 may determine a wallet category of the third wallet 124 based, at least in part, on the wallet category data. Herein, the wallet category may indicate a transaction category where the corresponding wallet is permitted or programmed to receive. Thus, it may be understood that the third wallet 124 is also linked with a smart contract such as a wallet smart contract.

Upon determining, the wallet category of the third wallet 124, the server system 102 may determine if the preexisting sub-wallet is eligible for transferring funds to the third wallet based, at least in part, on the wallet category and the transaction category of the preexisting sub-wallet. Later, in one embodiment, upon determining that the preexisting sub-wallet is eligible for transferring funds to the third wallet 124, the server system 102 may approve and transfer the digital currency from the preexisting sub-wallet to the third wallet 124 based on the fund transfer request. In another embodiment, upon determining that the preexisting sub-wallet is not eligible for transferring funds to the third wallet 124, the server system 102 may decline the fund transfer request.

In some embodiments, one or more financial institutions or one or more third-party applications such as the wallet providers can generate or create the wallets according to specific use case and event flow. In such embodiments, the financial institutions and the third-party applications may have to be approved for generating the corresponding wallets by a central entity such as a central bank of a country offering the digital currency such as the CBDC.

In some other embodiments, the financial institutions and/or the wallet providers can also provide credit/micro-loans to their users (e.g., the second user 110) according to a predefined logic that may be programmed (using the smart contract) in the CBDC itself. It is to be noted that these benefits can be extended to an offline setting as well. For instance, suppose a payment transaction linked with a smart contract is initiated from one wallet to another wallet. Upon receiving the transaction, if the receiving wallet is disconnected from the internet connection, the smart contract does not get executed. However, upon connecting back to the internet, the smart contract executes, and the transaction is completed or rejected based on the execution of the smart contract in the receiving wallet. Herein, in some scenarios, the receiving wallet may also be associated with a smart contract that executes to check its eligibility for receiving the corresponding payment transaction.

Also, the programmability feature of the CBDC can be implemented through a nested smart contract wallet (i.e., a wallet described earlier to have a nested smart contract feature). These smart contracts are pieces of code associated with a digital currency or a wallet that can self-execute payments based on some pre-defined criteria or conditions. For instance, one smart contract can trigger another smart contract, based on some conditions defined by a user or a group of users. Examples of the predefined criteria or conditions include fraud detection conditions, user authorization conditions, insurance coverage detection, discount offer eligibility and validity checking, and the like. For example, a condition in a smart contract linked to a digital currency can be to check whether a receiving wallet is owned by a retail owner that provides ration services. From this condition, the purpose of the smart contract is clear that, the digital currency is supposed to be used only for purchasing ration. Thus, upon receiving the digital currency, a wallet smart contract linked to the receiving wallet triggers the execution of the smart contract linked to the received digital currency. Once the condition is matched, the receiving wallet successfully receives the digital currency and utilizes the same for the purpose mentioned in the smart contract. Through the approach proposed in the present disclosure, citizens/government can use the programmability feature of the digital currency such as the CBDC according to their needs and regulate the flow of funds in the direction intended with case and convenience.

The number and arrangement of systems, devices, and/or networks shown in FIG. 1 are provided as an example. There may be additional systems, devices, and/or networks; fewer systems, devices, and/or networks; different systems, devices, and/or networks; and/or differently arranged systems, devices, and/or networks than those shown in FIG. 1. Furthermore, two or more systems or devices shown in FIG. 1 may be implemented within a single system or device, or a single system or device as shown in FIG. 1 may be implemented as multiple, distributed systems or devices. In addition, the server system 102 should be understood to be embodied in at least one computing device in communication with the network 118, which may be specifically configured, via executable instructions, to perform steps as described herein and/or embodied in at least one non-transitory computer-readable media.

More specifically, it should be noted that the number of first users, first user devices, second users, second user devices, third users, third user devices, first wallets, second wallets, third wallets, and database described herein are only used for exemplary purposes and do not limit the scope of the present disclosure. The main objective of the present disclosure is to provide an approach that can generate a digital infrastructure for the developers and/or payment providers to create their customized wallets for using programmable money and user-specific use cases using smart contract wallets.

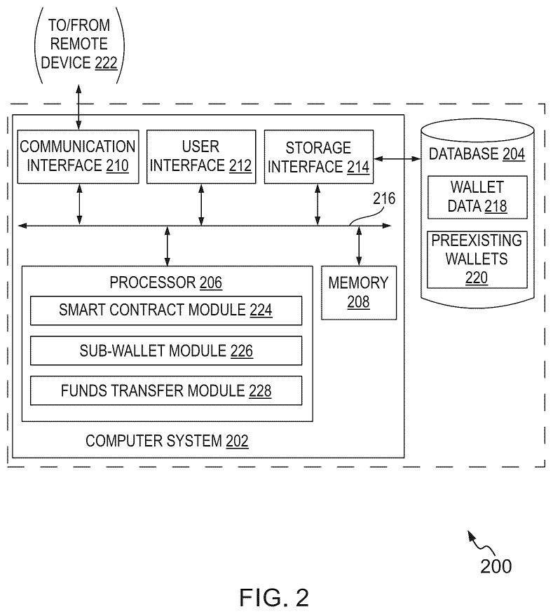

FIG. 2 illustrates a simplified block diagram of a server system 200, in accordance with an embodiment of the present disclosure. For example, the server system 200 is similar to the server system 102 as described in FIG. 1. In some embodiments, the server system 200 is embodied as a standalone physical server and/or has a cloud-based and/or SaaS-based (software as a service) architecture.

The server system 200 includes a computer system 202 and a database 204. The computer system 202 includes at least one processor, such as a processor 206 for executing instructions, a memory 208, a communication interface 210, a user interface 212, and a storage interface 214. The one or more components of the computer system 202 communicate with each other via a bus 216. The components of the server system 200 provided herein may not be exhaustive and the server system 200 may include more or fewer components than those depicted in FIG. 2. Further, two or more components depicted in FIG. 2 may be embodied in one single component, and/or one component may be configured using multiple sub-components to achieve the desired functionalities. The database 204 is an example of the database 116 of FIG. 1.

In some embodiments, the database 204 is integrated into the computer system 202. For example, the computer system 202 may include one or more hard disk drives as the database 204. In one non-limiting example, the database 204 is configured to store wallet data 218 and preexisting wallets 220. Herein, the wallet data 218 and the preexisting wallets 220 are similar to the wallet data 126 and the preexisting wallets 128 of FIG. 1.

Further, the computer system 202 may include one or more hard disk drives as the database 204. The user interface 212 is an interface such as a Human Machine Interface (HMI) or a software application that allows users such as an administrator to interact with and control the server system 200 or one or more parameters associated with the server system 200. It may be noted that the user interface 212 may be composed of several components that vary based on the complexity and purpose of the application. Examples of components of the user interface 212 may include visual elements, controls, navigation, feedback and alerts, user input and interaction, responsive design, user assistance and help, accessibility features, and the like. More specifically these components may correspond to icons, layout, color schemes, buttons, sliders, dropdown menus, tabs, links, error/success messages, mouse and touch interactions, keyboard shortcuts, tooltips, screen readers, and the like.

The storage interface 214 is any component capable of providing the processor 206 with access to the database 204. The storage interface 214 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 206 with access to the database 204.

It is to be noted that although the computer system 202 is depicted to include only one processor, the computer system 202 may include a greater number of processors therein. The processor 206 includes a suitable logic, circuitry, and/or interfaces to execute computer-readable instructions for performing one or more operations for managing programmable digital currency-based transactions through nested smart contract-based wallets. Examples of the processor 206 include, but are not limited to, an application-specific integrated circuit (ASIC) processor, a reduced instruction set computing (RISC) processor, a complex instruction set computing (CISC) processor, a field-programmable gate array (FPGA), and the like.

In one embodiment, the memory 208 is capable of storing the computer-readable instructions. Examples of the memory 208 include a random-access memory (RAM), a read-only memory (ROM), a removable storage drive, a hard disk drive (HDD), and the like. It will be apparent to a person skilled in the art that the scope of the disclosure is not limited to realizing the memory in the server system 200, as described herein. In another embodiment, the memory 208 may be realized in the form of a database server or cloud storage working in conjunction with the server system 200 without departing from the scope of the present disclosure.

The processor 206 is operatively coupled to the communication interface 210 such that the computer system 202 is capable of communicating with a remote device 222 such as the first user device 104, the second user device 108, the third user device 112, or with any entity connected to the network 118 (as shown in FIG. 1). In one embodiment, the processor 206 is configured to facilitate access to a URL associated with the website or the application corresponding to the server system 102 on the first user device 104, the second user device 108, and/or the third user device 112 or for remotely accessing the website or the application. This enables the implementation of a plurality of functionalities by multiple entities described in the disclosure.

It is to be noted that the server system 200 as illustrated and hereinafter described is merely illustrative of an apparatus that could benefit from embodiments of the present disclosure and, therefore, should not be taken to limit the scope of the present disclosure. It is noted that the server system 200 may include fewer or more components than those depicted in FIG. 2.

The processor 206 is depicted to include a smart contract module 224, a sub-wallet module 226, and a funds transfer module 228. It should be noted that components described herein can be configured in a variety of ways, including electronic circuitries, digital arithmetic, logic blocks, and memory systems in combination with software, firmware, and embedded technologies.

The smart contract module 224 may include suitable logic and/or interfaces for facilitating generation or creation of at least one smart contract including a set of predefined instructions, the at least one smart contract intended to execute the set of predefined instructions upon meeting a predefined condition. Herein, the predefined condition may be described in the set of predefined instructions. The smart contract module 224 may be further configured to link the at least one smart contract with a digital currency. Herein, the digital currency is to be transferred from a first wallet (e.g., the first wallet 120) to a second wallet (e.g., the second wallet 122) and then to a third wallet (e.g., the third wallet 124). The smart contract module 224 may further be configured to transfer the digital currency linked with the at least one smart contract to the second wallet 122.

The sub-wallet module 226 may include suitable logic and/or interfaces for generating and depositing the digital currency to one or more new sub-wallets associated with the second wallet 122 based, at least in part, on a transaction category of the digital currency. Herein, each of the one or more new sub-wallets is eligible to hold the digital currency for a specific transaction category.

In a specific embodiment, the sub-wallet module 226 is configured to generate one or more wallets such as the first wallet 120, the second wallet 122, the third wallet 124, and the like. The wallets may be created based, at least in part, on funds to be transferred through the digital currency. Further, for the generation of the wallets, the sub-wallet module 226 may be configured to generate one or more Application Programming Interface (API) endpoints for facilitating the exchange of one or more API calls between one or more wallet providers and corresponding one or more financial institutions. Herein, it is to be noted that each wallet provider may have a financial account in a particular financial institution. In a non-limiting example, the one or more wallet providers may include third-party platforms that can create wallets and provide them to wallet users such as the first user 106, the second user 110, and the third user 114. However, in some embodiments, the wallet providers may have to take permission from the corresponding financial institutions.

Thus, in one embodiment, the sub-wallet module 226 is configured to receive a wallet generation request from the one or more wallet providers through the one or more API endpoints. In another embodiment, the sub-wallet module 226 is configured to transfer the wallet generation request to the corresponding one or more financial institutions through the one or more API endpoints. Herein, the wallet generation request may be transferred to the financial institutions as an API call. The financial institutions may have to verify the identity of the wallet providers prior to facilitating the generation of the wallets for the wallet users.

Thus, in response to the wallet generation request, the sub-wallet module 226 may receive a wallet authorization response from the one or more financial institutions. Herein, the wallet authorization response may indicate an authorization of at least one of the one or more wallet providers based, at least in part, on the one or more API calls. Further, in response to the authorization of at least one of the one or more wallet providers, the sub-wallet module 226 may facilitate the corresponding wallet provider to create the one or more wallets.

In a non-limiting example, each of the wallets may be associated with one or more sub-wallets. In one embodiment, the one or more sub-wallets include one or more preexisting wallets. In another embodiment, the one or more sub-wallets include one or more new sub-wallets that may be newly created within a particular wallet.

In case of the one or more new sub-wallets being generated and used for depositing the received digital currency, the smart contract module 224 may be configured to link each of the one or more new sub-wallets with at least one wallet smart contract indicating a wallet eligibility condition. As described earlier, the received digital currency may be deposited in the one or more new sub-wallets based on the transaction category and the eligibility of the corresponding one or more new sub-wallets. Thus, for determining the eligibility of the new sub-wallets, in a non-limiting implementation, the smart contract module 224 may be configured to execute the at least one smart contract associated with the digital currency. Further, the smart contract module 224 may execute the at least one wallet smart contract associated with each of the one or more new sub-wallets.

Furthermore, in one embodiment, the smart contract module 224 may determine if at least one of the one or more new sub-wallets is eligible to hold the digital currency based at least on the execution of the at least one smart contract and the at least one wallet smart contract. In one scenario, the smart contract module 224 determines that the at least one of the one or more new sub-wallets is eligible to hold the digital currency when the execution of the at least one smart contract and the at least one wallet smart contract indicates that the purpose of the corresponding new sub-wallet matches with the transaction category of the digital currency. For instance, if the smart contract linked to the digital currency is for a ration subsidy and if the smart contract linked to the new sub-wallet also indicates that it accepts the payment for ration subsidy, then the new sub-wallet is considered to be eligible.

In an alternative scenario, the smart contract module 224 may determine that at least one of the one or more new sub-wallets is not eligible to hold the digital currency when the execution of the at least one smart contract and the at least one wallet smart contract indicates that the purpose of the corresponding new sub-wallet mismatches with the transaction category of the digital currency.

In an embodiment, the sub-wallet module 226 may be configured to deposit the digital currency to one or more preexisting sub-wallets (e.g., the preexisting sub-wallets 220). Herein, each of the one or more preexisting sub-wallets 220 is eligible to hold the digital currency for the specific transaction category. In such an embodiment, the smart contract module 224 may be configured to link each of the one or more preexisting sub-wallets with at least one wallet smart contract indicating the wallet eligibility condition. Further, as described earlier, the received digital currency may be deposited in the preexisting sub-wallets 220 based on the eligibility of the corresponding preexisting sub-wallets 220. Thus, for determining the eligibility of the preexisting sub-wallets, the smart contract module 224 may execute the at least one smart contract associated with the digital currency. The smart contract module 224 may further execute the at least one wallet smart contract associated with each of the preexisting sub-wallets 220.

Further, in one embodiment, the smart contract module 224 may determine if at least one of the preexisting sub-wallets 220 is eligible to hold the digital currency based at least on the execution of the at least one smart contract and the at least one wallet smart contract. In one scenario, the smart contract module 224 may determine that at least one of the preexisting sub-wallets 220 is eligible to hold the digital currency when the execution of the at least one smart contract and the at least one wallet smart contract indicates that the purpose of the corresponding preexisting sub-wallet matches with the transaction category of the digital currency.

In an alternative scenario, the smart contract module 224 may determine that at least one of the preexisting sub-wallets 220 is not eligible to hold the digital currency when the execution of the at least one smart contract and the at least one wallet smart contract indicates that the purpose of the corresponding preexisting sub-wallet mismatches with the transaction category of the digital currency.

The funds transfer module 228 may include suitable logic and/or interfaces for receiving a fund transfer of the digital currency from the first wallet 120 to the second wallet 122. Herein, the digital currency is associated with the at least one smart contract. Herein, the at least one smart contract includes the set of predefined instructions.

Further, the funds transfer module 228 may be configured to determine the transaction category of the digital currency based, at least in part, on the set of predefined instructions. Herein, the transaction category may indicate the purpose of the fund transfer as per the smart contract.

Furthermore, in an embodiment, the funds transfer module 228 may be configured to receive a fund transfer request from a wallet owner of the second wallet 122 to transfer funds to the third wallet 124. Herein, the fund transfer request is associated with the digital currency deposited in a preexisting sub-wallet of the second wallet 122.

Moreover, the funds transfer module 228 may be configured to access wallet category data from the database 204 associated with the server system 200. In an embodiment, the funds transfer module 228 may be configured to determine a wallet category of the third wallet 124 based, at least in part, on the wallet category data. The funds transfer module 228 may determine if the preexisting sub-wallet is eligible for transferring funds to the third wallet 124 based, at least in part, on the wallet category and the transaction category of the preexisting sub-wallet.

Further, in an embodiment, the funds transfer module 228 may be configured to approve and transfer the digital currency from the preexisting sub-wallet to the third wallet 124 based on the fund transfer request, upon determining that the preexisting sub-wallet is eligible for transferring funds to the third wallet 124.

In another embodiment, the funds transfer module 228 may be configured to decline the fund transfer request, upon determining that the preexisting sub-wallet is not eligible for transferring funds to the third wallet 124.

In a specific embodiment, the smart contract module 224 may be configured to link the third wallet 124 with at least one wallet smart contract indicating the wallet eligibility condition. Thus, for determining the eligibility of the preexisting sub-wallet to transfer the funds to the third wallet 124, the smart contract module 224 may execute the at least one smart contract associated with a digital currency of the funds and the at least one wallet smart contract associated with each of the preexisting sub-wallet and the third wallet 124.

In one embodiment, the smart contract module 224 may determine that the preexisting sub-wallet is eligible to transfer the funds in the digital currency to the third wallet 124 when the execution of the at least one smart contract and the at least one wallet smart contract indicates that the wallet category of the third wallet 124 matches with the transaction category of the preexisting sub-wallet.

In an alternative embodiment, the smart contract module 224 may determine that the preexisting sub-wallet is not eligible to transfer the funds in the digital currency to the third wallet 124 when the execution of the at least one smart contract and the at least one wallet smart contract indicates that the wallet category of the third wallet 124 mismatches with the transaction category of the preexisting sub-wallet.

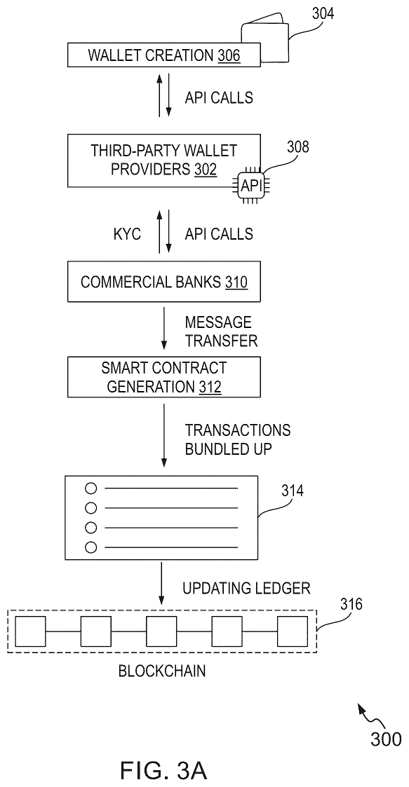

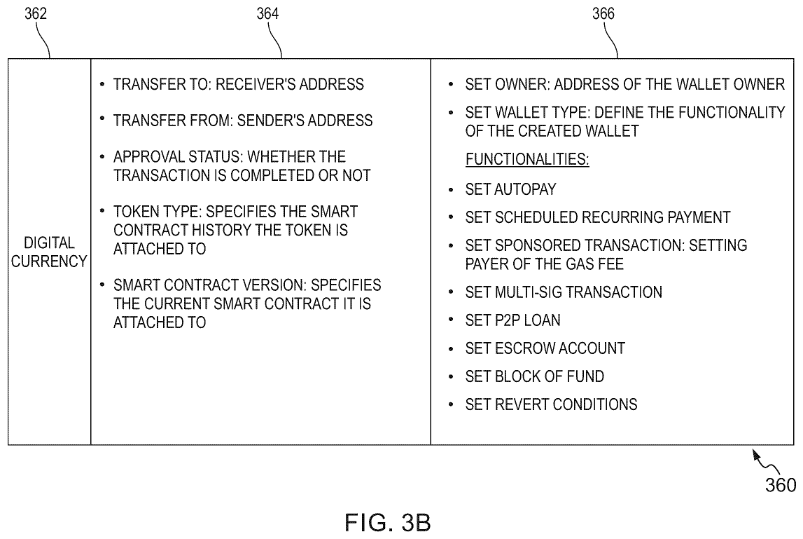

FIG. 3A illustrates a block diagram of a digital architecture 300 associated with the server system 200, in accordance with an embodiment of the present disclosure. As may be understood from the configuration of the server system 200 and the digital architecture 300 as shown in FIG. 3A, the digital architecture 300 facilitates third-party wallet providers 302 to create wallets 304 using a process of a wallet creation (see, 306). Herein, the third-party wallet providers 302 are examples of entities that provide services of the server system 200 to the wallet users. Further, it is noted that the wallet creation process is a well-known process for those skilled in the art and, hence, not described for the sake of brevity. In a non-limiting example, the wallets 304 applies to a smart wallet. Thus, in one embodiment, the wallets 304 may be associated with a smart contract such as a wallet smart contract. Moreover, the wallets 304 may be similar to the wallets such as the first wallet 120, the second wallet 122, and the third wallet 124 of FIG. 1.

The wallets 304 are accessible to wallet users (e.g., the first user 106, the second user 110, and the third user 114) so that the wallet users can initiate a fund transfer between at least two wallets (e.g., the first wallet 120 and the second wallet 122). Herein, it may be noted that, in some non-limiting examples, the wallet creation 306 may be facilitated using Application Programming Interfaces (APIs) 308 provided by commercial banks (see, 310). Herein, the commercial banks 310 is an example of a financial institution in which the third-party wallet providers 302 have an account.

In other words, it may be noted that the wallet creation 306 is made possible by making multiple API calls between the third-party wallet providers 302 and the commercial banks 310 via the APIs 308. As described earlier, the server system 200 generates the API endpoints facilitating the exchange of the API calls between the wallet providers 302 and the financial institutions such as the commercial banks 310. Further, during this process, Know Your Customer (KYC) may also be performed to authorize the third-party wallet providers 302 to create or generate the wallets 304 upon seeking permission from the commercial banks 310.

Further, as the wallets 304 are being created for storing and transferring funds in digital currency, a process of smart contract generation (see, 312) may also be implemented via the server system 200. This process may be implemented for the generation of smart contracts (see, 314) in a way as explained with reference to FIGS. 1 and 2. Herein, the smart contracts 314 may be generated upon receiving aggregated messages from the commercial banks 310 describing the purpose of the fund transfer. Further, it may be noted that the aggregated messages that the commercial banks 310 may transfer for the smart contract generation 312 may be received and aggregated from the third-party wallet providers 302.

In an embodiment, the smart contracts 314 may have transactions bundled up within it that are programmed for a specific purpose, based on the aggregated messages. Upon generating the smart contracts 314, the transactions that are bundled up may be updated to the ledger (e.g., a Blockchain 316) as shown in FIG. 3. In a specific example, the digital currency can be a CBDC token which can be exchanged between the wallets such as CBDC smart wallets. Herein, the CBDC token corresponds to a token that is associated with the CBDC while transferring it from one wallet to another.

In a non-limiting example, a pseudo code for an implementation of a smart contract associated with a CBDC token upon transferring the CBDC token from the second user 110 to the third user 114 is as follows:

Initialize token parameters and assign a total supply to a contract creator;
Transfer tokens from a message sender to a specified recipient;
Approve the specified spender to spend tokens on behalf of the message sender; and
Transfer tokens from one account to another using an approved allowance.

As may be understood, the token parameters of the CBDC token are initialized as per the smart contract linked with the corresponding CBDC token. Simultaneously, a total supply is also assigned to a contract creator. Further, the tokens such as the CBDC token is sent from the message sender such as the second user 110 to the specified recipient such as the third user 114. Later, the specified spender, i.e., the third user 114 is allowed to spend the CBDC token. As the third user 114 is allowed to spend the CBDC token, the CBDC token can be sent to any account using the approved allowance.

In a non-limiting example, a pseudo code for an implementation of a smart contract associated with a CBDC smart wallet is as follows:

Initialize a wallet with a provided CBDC token contract and wallet type;
Set a contract creator as an initial owner;
Change the wallet owner to the specified new owner;
Set a new wallet type for the wallet;
Schedule an AutoPay transaction to a specified recipient within a given interval;
Schedule a Recurring Payment to the specified recipient within the given interval;
Allow a third party to sponsor a transaction's gas fee for the specified recipient; and
Schedule a multi-sig transaction to the specified recipient with the specified amount.

As may be understood, initially, a wallet such as the second wallet 122 is initialized with the CBDC token contract and a wallet type associated with the corresponding second wallet 122. Herein, the contract creator of the CBDC token contract is declared to be the initial owner of the CBDC token contract. Further, for the sake of the transaction of the CBDC token to a new wallet such as the third wallet 124, a new owner of the third wallet 124 is made as a wallet owner. Further, a new wallet type is assigned to the third wallet 124. Furthermore, as per the smart contract linked to the CBDC smart wallet, an autopay transaction, a recurring payment, a multi-signature (multi-sig) transaction, allowing a third party to sponsor a transaction's gas fee for a specific recipient such as the third wallet 124, and the like.

FIG. 3B illustrates a schematic representation 360 of a digital currency (e.g., a digital currency 362 or CBDC token 362) linked with a smart contract (e.g., a CBDC token contract 364), and a smart wallet contract (e.g., a smart wallet contract 366), in accordance with an embodiment of the present disclosure. As may be understood, an example of a digital currency may be a CBDC token 362 which, during fund transfer, may be linked with the CBDC token contract 364 and the smart wallet contract 366. Herein, it may be noted that the digital currency is linked with the smart wallet contract 366. Also, herein, the smart wallet contract 366 may be linked to a wallet that may receive the CBDC token 362. This aspect implies that the wallet transferring the funds (e.g., the digital currency 362) and the wallet receiving the digital currency 362 may be a smart wallet or linked with a smart contract such as a wallet smart contract.

Further, as may be understood that the pseudo-code for the CBDC token contract 364 and the smart wallet contract 366 are explained above with reference to FIG. 3A. Herein, referring to FIG. 3B, the CBDC token contract 364 may include the following details:
Transfer to: Receiver's Address
Transfer from: Sender's Address
Approval status: Whether the transaction is completed or not
Token Type: Specifies the smart contract history the token is attached to
Smart Contract Version: Specifies the current smart contract version it is attached to

Herein, it may be understood that the ‘token type’ may help in auditing of the digital currency. This as a result provides enhanced traceability for certain use cases. Further, the ‘smart contract version’ may help in updating the attached smart contract version if required.

Furthermore, it may be noted that the smart wallet contract 366 may include the following details:
Set Owner: Address of the wallet owner
Set Wallet Type: Define the functionality of the created wallet
Functionalities
   Set AutoPay
   Set Scheduled Recurring Payment
   Set Sponsored Transaction: Setting Payer of the Gas fee
   Set Multi sig Transaction
   Set P2P loan
   Set Escrow account
   Set block of fund
   Set Revert conditions

It is noted that the approach proposed in the present disclosure is not limited to the above-mentioned functionalities. To that end, in various non-limiting examples, the functionalities may include any possible application of the smart contracts such as setting autopay, setting scheduled recurring payment, setting sponsored transactions, setting multi-signature transactions, setting Peer-to-Peer (P2P) loans, setting escrow account, setting block of funds, setting transaction reverse conditions, and the like. Herein, upon referring to the details included in the smart wallet contract 366, it may be understood that along with including owner details and wallet type, it may also include defining additional functionalities for the smart wallet that it can perform upon execution of the smart wallet contract 366 during the fund transfer of the digital currency 362.

For example, the CBDC token 362 is to be transferred from the smart wallet such as W1 to another smart wallet such as W2. Suppose WI has the address ‘address1’ and the address of W2 is ‘address2’. Thus, the smart contract such as the CBDC token contract 364 linked to the CBDC token 362 may have the addresses ‘address1’ and ‘address2’ mentioned. Further, the CBDC token 362 may have been used earlier by other users for other purposes. Thus, the CBDC token contract 364 may also disclose the history of usage of the CBDC token 362. Furthermore, it is to be noted that, generally, smart contracts have an associated version, meaning that the contract has been iterated upon and updated to reflect changes, improvements, or bug fixes. Thus, the CBDC token contract 364 also mentions the smart contract version of the corresponding CBDC token contract 364 linked to the CBDC token 362. Upon transferring the CBDC token 362 from W1 to W2, the CBDC token contract 364 may execute at W2. Upon execution, the transaction may be approved or rejected based on the condition described in the CBDC token contract 364. Suppose the condition is to check the address of the wallet to be ‘address2’, and if the address matches, the transaction is completed, otherwise rejected. Upon execution of the CBDC token contract 364, the approval status in the CBDC token contract 364 may be updated based on the execution result. Suppose the transaction is completed, and W2 has received the CBDC token 362. As may be understood, the smart wallet W2 is also linked with the smart wallet contract 366. According to this contract, the address of W2 is clear, and its type, i.e., functionalities (as described earlier) facilitated by the wallet W2. For instance, if the functionality of W2 is to make scheduled recurrent payment towards a loan repayment. Then, upon receiving the funds as the CBDC token 362, the same may be spent from W2 automatically as per the schedule of the scheduled recurrent payment. Herein, W2 may have to keep receiving funds from W1, so that the payment towards the scheduled recurrent payment is made on time. Otherwise, the account may be blocked and a user of W1 may have to make a penalty payment.

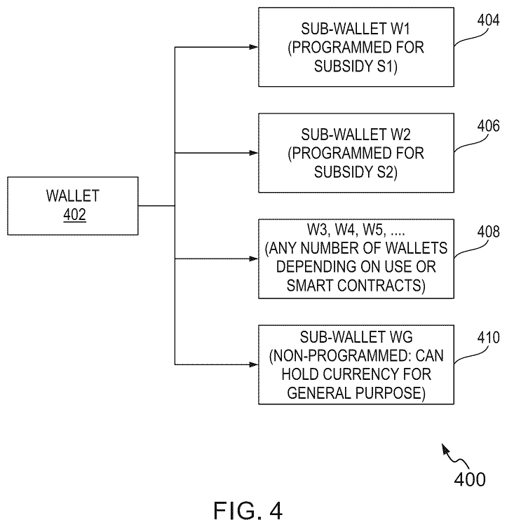

FIG. 4 illustrates a block diagram 400 of an example wallet (e.g., a wallet 402) having one or more sub-wallets, in accordance with an embodiment of the present disclosure. Herein, the wallet 402 may be similar to the wallet 304 of FIG. 3A. It may be noted that, due to flexibility in user authentication, the wallet providers (e.g., the third-party wallet providers 302) can onboard a large share of the population into using retail CBDC. As a result, trust and security are improved. Also, the wallet providers can create use-case-specific event-flows, which will further drive the adoption of retail CBDC.

Further, as may be understood, the programmable money or the programmable currency has a number of use cases. One of the examples includes a government (govt.) decentralized Subsidy Scheme. In such an example, in a scenario where the govt. wants to give an amount in the form of a CBDC for subsidizing any item (e.g., a Public Distribution System (PDS) for Below the Poverty Line (BPL) people), the CBDC which is sent to the beneficiaries will be programmed in such a way that this CBDC can only be spent at certain merchants (e.g., the merchants who sell the ration in that locality).

Another example includes parental control over family wallets. In such an example, it may be noted that one can program the wallets of their family members directly or with any third-party help. For instance, parents who send money to children's wallets can program the currency to be used/not to be used at certain locations/merchants (e.g., only to use for paying school fees, not to be used at liquor stores, etc.).

Yet another example includes using this facility at private firms (e.g., programming funds given to employees by the companies to be used or redeemed only for business trips). Further, another example includes the facility of giving microloans through generated credit history. In such an example, when a bank has information about all the transactions from a particular wallet, this history can be used to generate the credit scores of individuals. Herein, such information may be useful in cases where people do not have any established credit history.

Furthermore, another example includes automating loyalty programs. In such an example, a merchant having the history of a customer's transaction at his store would help the merchant to use this information for loyalty programs. Moreover, in some examples, the physical coupons given by merchants to customers now can be replaced with a smart contract (e.g., a cashback but a programmed cashback), which the customer can use only at a store fixed by the merchant (e.g., a currency can be programmed as per merchant needs, details like location of usage, limit at one time, expiry date can be pre-set, etc.). Yet another example includes improvement in P2P lending (e.g., Escrow-based services for Business Owners).

To that note, examples of sub-wallets that can be created within the wallet 402 may include a sub-wallet W1 that is programmed for subsidy S1 (see, 404), a sub-wallet W2 that is programmed for subsidy S2 (see, 406), and sub-wallets W3, W4, W5, and any number of sub-wallets depending on the use or smart contracts (see, 408). In an embodiment, the sub-wallets may further include a sub-wallet WG (see, 410) that may be non-programmed and hence can hold currency for general purposes.

Further, in a non-limiting example, the network 118 such as the blockchain network that may be used for the implementation of the server system 200 may be the Ethereum network. In another non-limiting example, the network 118 may include a new network that has the capability of account abstract. For example, EIP-4337 may be used to introduce account abstraction without any changes to the core blockchain network. Further, it may be noted that architectural choices may play a major role in the adoption of the present disclosure.

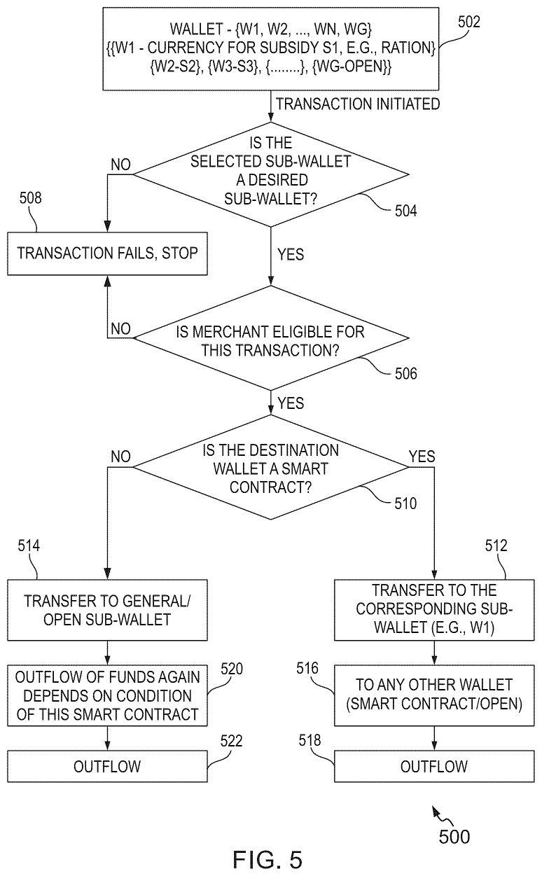

FIG. 5 illustrates a block diagram of a flow 500 of a fund transfer from a source wallet to a destination wallet, in accordance with an embodiment of the present disclosure. Assuming that the source wallet may be a wallet of the government that is willing to provide funds to the public for subsidizing one or more items. Herein, the source wallet and the public may be substantially similar to the first wallet 120 and the second user 110 respectively of FIG. 1. Therefore, upon receiving the fund transfer and determining a transaction category, the server system 200 either generates new sub-wallets or utilizes preexisting sub-wallets within a main wallet of the second user 110. Herein, the main wallet of the second user 110 corresponds to the second wallet 122. Therefore, in either of the cases, the sub-wallets may include W1, W2, W3, . . . WN, WG as shown in FIG. 5 (see, 502). Herein, the sub-wallets are similar to the sub-wallets as explained with reference to FIG. 4. Also, ‘N’ is a non-zero natural number, and ‘G’ indicates a general wallet which is a wallet that is non-programmed and can hold the digital currency for a general purpose.

Once people receive the funds from the government for a particular subsidy, they are now free to use it. However, they are restricted to using that money only for the corresponding subsidy. Earlier, there was a possibility that people might use the money sanctioned by the government under the subsidy of ration for other purposes such as for purchasing alcohol or any other items. Also, some people who are not actually in need of such a subsidy may take it and use it for other personal benefits. This fails the motive of the government of helping underprivileged people, as people above the poverty line were able to misuse such facilities from the government given that there was no means of tracking the flow of money. With the introduction of the present disclosure, now the government can easily keep track of the money sanctioned by them and make sure that it is been used for the same purpose for which it was sanctioned earlier.

Therefore, when an individual such as the second user 110 initiates the transaction as shown in FIG. 5, the server system 200 may check whether the selected sub-wallet is the sub-wallet that is eligible for the desired subsidy that the second user 110 is willing to utilize (see, 504). If yes, a merchant's eligibility for receiving this transaction is checked (see, 506). If no, the transaction fails, and the process initiated by the second user 110 stops (see, 508).

Further, at 506, while checking the merchant's eligibility, if the merchant is eligible to receive the funds, then the funds are transferred to a merchant's wallet (similar to the third wallet 124 of the third user 114 as explained in FIG. 1). Otherwise, the transaction fails, and the process stops as in step 508.

Furthermore, at the merchant end, the server system 200 may check if the destination wallet i.e., the merchant's wallet is associated with a smart contract (see, 510). If yes, and if the subsidy is S1, then the funds get transferred to a sub-wallet say W1 (see, 512). Otherwise, the funds may be transferred to a general sub-wallet (i.e., WG) that is not associated with any smart contract (see, 514).

In addition, the process may continue in case the fund transfer has happened in the sub-wallet W1 which is associated with a smart contract. Herein, the next transfer would be based on the smart contract for the execution of the corresponding smart contract and ending the process (see, 516). After this, the funds may outflow (see, 518) if no smart contract is further linked to the transaction.

Alternatively, when the funds get transferred to the general wallet as in step 514, the next transfer may again be a dependent condition of the smart contract if any is linked to the transaction (see, 520). Later, here also the funds may outflow (see, 522) if no smart contract is further linked to the transaction. To that end, the proposed approach prevents the misappropriation of funds allocated to an individual.

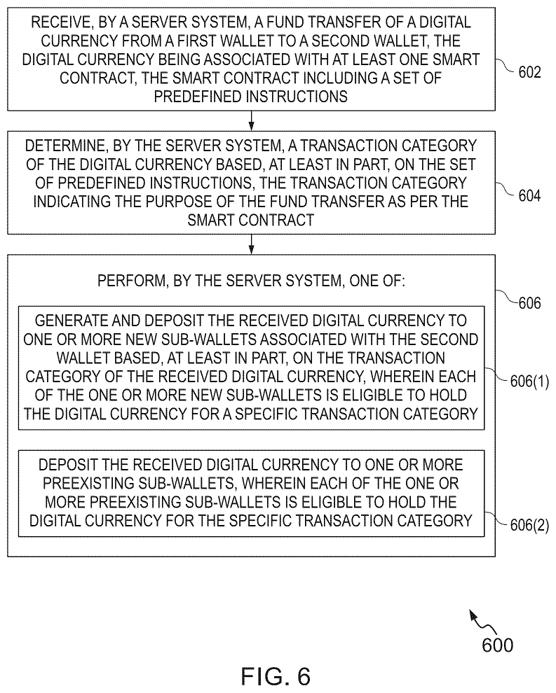

FIG. 6 illustrates a process flow diagram depicting a method 600 for facilitating a fund transfer from a first wallet (e.g., the first wallet 120) to a second wallet (e.g., the second wallet 122), in accordance with an embodiment of the present disclosure. The method 600 depicted in the flow diagram may be executed by, for example, the server system 200. The sequence of operations of the method 600 may not be necessarily executed in the same order as they are presented. Further, one or more operations may be grouped and performed in the form of a single step, or one operation may have several sub-steps that may be performed in parallel or in a sequential manner. Operations of the method 600, and combinations of operations in the method 600 may be implemented by, for example, hardware, firmware, a processor, circuitry, and/or a different device associated with the execution of software that includes one or more computer program instructions. The plurality of operations is depicted in the process flow of the method 600. The process flow starts at operation 602.

At 602, the method 600 includes receiving, by a server system (e.g., the server system 200), a fund transfer of a digital currency from the first wallet 120 to the second wallet 122. Herein, the digital currency is associated with at least one smart contract. Herein, the smart contract includes a set of predefined instructions.

At 604, the method 600 includes determining, by the server system 200, a transaction category of the digital currency based, at least in part, on the set of predefined instructions. Herein, the transaction category indicates the purpose of the fund transfer as per the smart contract.

At 606, the method 600 includes performing, by the server system 200, one of sub-steps 606(1) and 606(2).

At 606(1), the method 600 includes generating and depositing the received digital currency to one or more new sub-wallets associated with the second wallet 122 based, at least in part, on the transaction category of the received digital currency. Herein, each of the one or more new sub-wallets is eligible to hold the digital currency for a specific transaction category.

At 606(2), the method 600 includes depositing the received digital currency to one or more preexisting sub-wallets. Herein, each of the one or more preexisting sub-wallets is eligible to hold the digital currency for the specific transaction category.

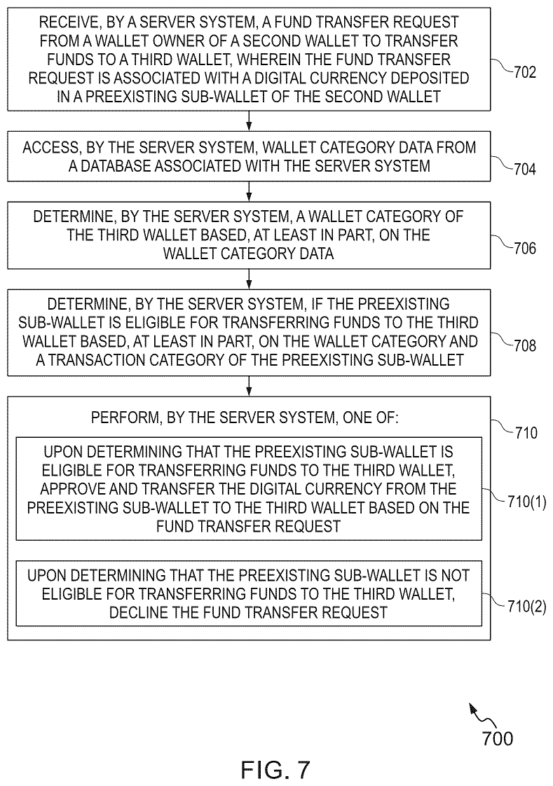

FIG. 7 illustrates a process flow diagram depicting a method 700 for facilitating a fund transfer from a second wallet (e.g., the second wallet 122) to a third wallet (e.g., the third wallet 124), in accordance with an embodiment of the present disclosure. The method 700 depicted in the flow diagram may be executed by, for example, the server system 200. The sequence of operations of the method 700 may not be necessarily executed in the same order as they are presented. Further, one or more operations may be grouped and performed in the form of a single step, or one operation may have several sub-steps that may be performed in parallel or in a sequential manner. Operations of the method 700 and combinations of operations in the method 700 may be implemented by, for example, hardware, firmware, a processor, circuitry, and/or a different device associated with the execution of software that includes one or more computer program instructions. The plurality of operations is depicted in the process flow of the method 700. The process flow starts at operation 702.

At 702, the method 700 includes receiving, by a server system (e.g., the server system 200), a fund transfer request from a wallet owner of the second wallet 122 to transfer funds to the third wallet 124. Herein, the fund transfer request is associated with a digital currency deposited in a preexisting sub-wallet of the second wallet 122.

At 704, the method 700 includes accessing, by the server system 200, wallet category data from a database (e.g., the database 204) associated with the server system 200.

At 706, the method 700 includes determining, by the server system 200, a wallet category of the third wallet 124 based, at least in part, on the wallet category data.

At 708, the method 700 includes determining, by the server system 200, if the preexisting sub-wallet is eligible for transferring funds to the third wallet 124 based, at least in part, on the wallet category and a transaction category of the preexisting sub-wallet.

At 710, the method 700 includes performing, by the server system 200, one of sub-steps 710(1) and 710(2).

At 710(1), the method 700 includes upon determining that the preexisting sub-wallet is eligible for transferring funds to the third wallet 124, approving and transferring the digital currency from the preexisting sub-wallet to the third wallet 124 based on the fund transfer request.

At 710(2), the method 700 includes upon determining that the preexisting sub-wallet is not eligible for transferring funds to the third wallet 124, declining the fund transfer request.

Various embodiments of the approach proposed in the present disclosure (i.e., the proposed approach), as discussed above, may be practiced with steps and/or operations in a different order, and/or with hardware elements in configurations, which are different from those which are disclosed. Therefore, although the proposed approach has been described based on these exemplary embodiments, it is noted that certain modifications, variations, and alternative constructions may be apparent and well within the scope of the proposed approach.

Although various exemplary embodiments of the proposed approach are described herein in a language specific to structural features and/or methodological acts, the subject matter defined in the appended claims is not necessarily limited to the specific features or acts described above. Rather, the specific features and acts described above are disclosed as exemplary forms of implementing the claim.

We claim:

1. A computer-implemented method, comprising:
receiving, by a server system, a fund transfer of a digital currency from a first wallet to a second wallet, the digital currency being associated with at least one smart contract, the smart contract comprising a set of predefined instructions;
determining, by the server system, a transaction category of the digital currency based, at least in part, on the set of predefined instructions, the transaction category indicating the purpose of the fund transfer as per the smart contract; and
performing, by the server system, one of:
generating and depositing the received digital currency to one or more new sub-wallets associated with the second wallet based, at least in part, on the transaction category of the received digital currency, wherein each of the one or more new sub-wallets is eligible to hold the digital currency for a specific transaction category; and
depositing the received digital currency to one or more preexisting sub-wallets, wherein each of the one or more preexisting sub-wallets is eligible to hold the digital currency for the specific transaction category.

2. The computer-implemented method as claimed in claim 1, further comprising:
facilitating, by the server system, generation of the at least one smart contract comprising the set of predefined instructions, the at least one smart contract intended to execute the set of predefined instructions upon meeting a predefined condition;
linking, by the server system, the at least one smart contract with the digital currency; and
transferring, by the server system, the digital currency linked with the at least one smart contract to the second wallet.

3. The computer-implemented method as claimed in claim 1, further comprising:
generating, by the server system, one or more wallets comprising the first wallet, the second wallet, and a third wallet based, at least in part, on funds to be transferred through the digital currency.

4. The computer-implemented method as claimed in claim 3, wherein generating the one or more wallets comprises:
generating, by the server system, one or more Application Programming Interface (API) endpoints for facilitating exchange of one or more API calls between one or more wallet providers and corresponding one or more financial institutions;
receiving, by the server system, a wallet generation request from the one or more wallet providers through the one or more API endpoints;
transferring, by the server system, the wallet generation request to the corresponding one or more financial institutions through the one or more API endpoints;
in response to the wallet generation request, receiving, by the server system, a wallet authorization response from the one or more financial institutions, the wallet authorization response indicating an authorization of at least one of the one or more wallet providers based, at least in part, on the one or more API calls; and
in response to the authorization of at least one of the one or more wallet providers, facilitating, by the server system, the corresponding wallet provider to create the one or more wallets.

5. The computer-implemented method as claimed in claim 1, further comprising:
linking, by the server system, each of the one or more new sub-wallets with at least one wallet smart contract indicating a wallet eligibility condition.

6. The computer-implemented method as claimed in claim 5, further comprising:
determining, by the server system, an eligibility of the one or more new sub-wallets to hold the digital currency for the specific transaction category, wherein determining the eligibility comprises:
executing the at least one smart contract associated with the digital currency and the at least one wallet smart contract associated with each of the one or more new sub-wallets; and
determining if at least one of the one or more new sub-wallets is eligible to hold the digital currency based at least on the execution of the at least one smart contract and the at least one wallet smart contract.

7. The computer-implemented method as claimed in claim 6, wherein determining if the at least one of the one or more new sub-wallets is eligible to hold the digital currency comprises one of:
determining that at least one of the one or more new sub-wallets is eligible to hold the digital currency when the execution of the at least one smart contract and the at least one wallet smart contract indicates that the purpose of the corresponding new sub-wallet matches with the transaction category of the digital currency; and
determining that at least one of the one or more new sub-wallets is not eligible when the execution of the at least one smart contract and the at least one wallet smart contract indicates that the purpose of the corresponding new sub-wallet mismatches with the transaction category of the digital currency.

8. The computer-implemented method as claimed in claim 1, further comprising:
linking, by the server system, each of the one or more preexisting sub-wallets with at least one wallet smart contract indicating a wallet eligibility condition.

9. The computer-implemented method as claimed in claim 8, further comprising:
determining, by the server system, an eligibility of the one or more preexisting sub-wallets to hold the digital currency for the specific transaction category, wherein determining the eligibility comprises:
executing the at least one smart contract associated with the digital currency and the at least one wallet smart contract associated with each of the one or more preexisting sub-wallets; and
determining if at least one of the one or more preexisting sub-wallets is eligible to hold the digital currency based at least on the execution of the at least one smart contract and the at least one wallet smart contract.

10. The computer-implemented method as claimed in claim 9, wherein determining if the at least one of the one or more preexisting sub-wallets is eligible to hold the digital currency comprises one of:
determining that at least one of the one or more preexisting sub-wallets is eligible to hold the digital currency when the execution of the at least one smart contract and the at least one wallet smart contract indicates that the purpose of the corresponding preexisting sub-wallet matches with the transaction category of the digital currency; and
determining that at least one of the one or more preexisting sub-wallets is not eligible to hold the digital currency when the execution of the at least one smart contract and the at least one wallet smart contract indicates that the purpose of the corresponding preexisting sub-wallet mismatches with the transaction category of the digital currency.

11. The computer-implemented method as claimed in claim 1, further comprising:
receiving, by the server system, a fund transfer request from a wallet owner of the second wallet to transfer funds to a third wallet, wherein the fund transfer request is associated with the digital currency deposited in a preexisting sub-wallet of the second wallet;
accessing, by the server system, wallet category data from a database associated with the server system;
determining, by the server system, a wallet category of the third wallet based, at least in part, on the wallet category data;
determining, by the server system, if the preexisting sub-wallet is eligible for transferring funds to the third wallet based, at least in part, on the wallet category and the transaction category of the preexisting sub-wallet; and
performing, by the server system, one of:
upon determining that the preexisting sub-wallet is eligible for transferring funds to the third wallet, approving and transferring the digital currency from the preexisting sub-wallet to the third wallet based on the fund transfer request; and
upon determining that the preexisting sub-wallet is not eligible for transferring funds to the third wallet, declining the fund transfer request.

12. A computer-implemented method, comprising:
receiving, by a server system, a fund transfer request from a wallet owner of a second wallet to transfer funds to a third wallet, wherein the fund transfer request is associated with a digital currency deposited in a preexisting sub-wallet of the second wallet;
accessing, by the server system, wallet category data from a database associated with the server system;
determining, by the server system, a wallet category of the third wallet based, at least in part, on the wallet category data;
determining, by the server system, if the preexisting sub-wallet is eligible for transferring funds to the third wallet based, at least in part, on the wallet category and a transaction category of the preexisting sub-wallet; and
performing, by the server system, one of:
upon determining that the preexisting sub-wallet is eligible for transferring funds to the third wallet, approving and transferring the digital currency from the preexisting sub-wallet to the third wallet based on the fund transfer request; and
upon determining that the preexisting sub-wallet is not eligible for transferring funds to the third wallet, declining the fund transfer request.

13. The computer-implemented method as claimed in claim 12, further comprising:
linking, by the server system, the third wallet with at least one wallet smart contract indicating a wallet eligibility condition.

14. The computer-implemented method as claimed in claim 13, further comprising:
determining, by the server system, an eligibility of the preexisting sub-wallet to transfer the funds to the third wallet, wherein determining the eligibility comprises:
executing the at least one smart contract associated with a digital currency of the funds and the at least one wallet smart contract associated with each of the preexisting sub-wallet and the third wallet; and
determining that the preexisting sub-wallet is eligible to transfer the funds in the digital currency to the third wallet when the execution of the at least one smart contract and the at least one wallet smart contract indicates that the wallet category of the third wallet matches with the transaction category of the preexisting sub-wallet.

15. The computer-implemented method as claimed in claim 14, further comprising:
determining, by the server system, that the preexisting sub-wallet is not eligible to transfer the funds in the digital currency to the third wallet when the execution of the at least one smart contract and the at least one wallet smart contract indicates that the wallet category of the third wallet mismatches with the transaction category of the preexisting sub-wallet.

16. A server system, comprising:
a communication interface;
a memory comprising executable instructions; and
a processor communicably coupled to the communication interface and the memory, the processor configured to cause the server system to at least:
receive a fund transfer of a digital currency from a first wallet to a second wallet, the digital currency being associated with at least one smart contract, the smart contract comprising a set of predefined instructions;
determine a transaction category of the digital currency based, at least in part, on the set of predefined instructions, the transaction category indicating the purpose of the fund transfer as per the smart contract; and
perform one of:
generate and deposit the received digital currency to one or more new sub-wallets associated with the second wallet based, at least in part, on the transaction category of the received digital currency, wherein each of the one or more new sub-wallets is eligible to hold the digital currency for a specific transaction category; and
deposit the received digital currency to one or more preexisting sub-wallets, wherein each of the one or more preexisting sub-wallets is eligible to hold the digital currency for the specific transaction category.

17. The server system as claimed in claim 16, wherein the server system is further caused, at least in part, to:
facilitate generation of the at least one smart contract comprising the set of predefined instructions, the at least one smart contract intended to execute the set of predefined instructions upon meeting a predefined condition;
link the at least one smart contract with the digital currency that is to be transferred from the first wallet to the second wallet; and
transfer the digital currency linked with the at least one smart contract to the second wallet.

18. The server system as claimed in claim 16, wherein the server system is further caused, at least in part, to generate one or more wallets comprising the first wallet, the second wallet, and a third wallet based, at least in part, on funds to be transferred through the digital currency.

19. The server system as claimed in claim 16, wherein the server system is further caused, at least in part, to link each of the one or more new sub-wallets with at least one wallet smart contract indicating a wallet eligibility condition.

20. The server system as claimed in claim 16, wherein the server system is further caused, at least in part, to link each of the one or more preexisting sub-wallets with at least one wallet smart contract indicating a wallet eligibility condition.
